(19) United States
(12) Patent Application Publication
(10) Pub. No.: US 2026/0365269 A1
(43) Pub. Date: Nov. 19, 2026

(54) STRADDLED VEHICLE

(71) Applicant: YAMAHA HATSUDOKI KABUSHIKI KAISHA, Iwata-shi (JP)

(72) Inventor: Wataru ARITA, Shizuoka (JP)

(21) Appl. No.: 19/673,342

(22) Filed: May 11, 2026

(30) Foreign Application Priority Data
May 14, 2025 (JP) 2025-081334

(51) Int. Cl. B62K 11/04; B62K 19/34

(52) U.S. Cl. CPC B62K 11/04; B62K 19/34

(57) ABSTRACT

A straddled vehicle, including: a head pipe; a left upper frame and a right upper frame both connected to the head pipe and extending rearward; a down frame connected to the head pipe, extending rearward, and arranged below the left and right upper frames; an engine that is supported by the left and right upper frames and the down frame; a swing arm, including a front end portion, and a rear end portion rotatably supporting a rear wheel of the straddled vehicle; a pivot shaft pivotally supporting the front end portion of the swing arm; and a pivot bracket attached to the engine, the pivot bracket having a through hole, which is open in a left-right direction of the straddled vehicle, formed therein. The pivot shaft is inserted through the through hole of the pivot bracket and is supported by the left upper frame and the right upper frame.

### CROSS-REFERENCE TO RELATED APPLICATIONS

The present application claims priority based on Japanese Patent Application No. 2025-081334, filed on May 14, 2025, the disclosure of which is hereby incorporated by reference in its entirety.

### BACKGROUND OF THE INVENTION

### Field of the Invention

The present invention relates to a straddled vehicle.

### Description of Related Art

JP 2006-62646 A and JP 2014-184754 A disclose a motorcycle that includes a head pipe, a frame extending rearward from the head pipe, an engine supported on the frame, and a rear swing arm. The front end portion of the rear swing arm is pivotally supported on a pivot shaft. The rear portion of the rear swing arm supports the rear wheel. With the motorcycle disclosed in JP 2006-62646 A, the pivot shaft is inserted through the rear portion of the crankcase of the engine, and is supported on the crankcase. With the motorcycle disclosed in JP 2014-184754 A, a pivot bracket is linked to the crankcase of the engine. The pivot shaft is inserted through the pivot bracket, and is supported on the pivot bracket.

Now, with straddled vehicles, vehicle characteristics can be adjusted by appropriately setting the position of the pivot shaft. For example, by appropriately setting the position of the pivot shaft, it is possible to adjust the rigidity of the frame or the engine, and the anti-squat ratio, etc., of the vehicle.

With straddled vehicles where the pivot shaft is inserted through the crankcase, changing the position of the pivot shaft requires changing the structure of the crankcase. However, it is troublesome to later change the structure of the crankcase each time the pivot shaft is changed.

With the motorcycle disclosed in JP 2014-184754 A, by redesigning the pivot bracket according to the change of the position of pivot shaft, there is no need to change the structure of the crankcase. However, the motorcycle disclosed in JP 2014-184754 A requires a large and heavy pivot bracket. Therefore, there is a problem of the straddled vehicle becoming heavier.

### SUMMARY OF THE INVENTION

The present invention has been made in view of this problem, and it is an object thereof to provide a straddled vehicle where the position of the pivot shaft can be changed without changing the structure of the crankcase of the engine and where weight increase is suppressed.

A straddled vehicle disclosed herein includes: a head pipe; a left upper frame connected to the head pipe and extending rearward; a right upper frame connected to the head pipe, extending rearward, and arranged rightward of the left upper frame; a down frame connected to the head pipe, extending rearward, and arranged downward relative to the left upper frame and the right upper frame; an engine supported on the left upper frame, the right upper frame, and the down frame; a swing arm including a front end portion and a rear end portion rotatably supporting a rear wheel; a pivot shaft pivotally supporting the front end portion of the swing arm; and a pivot bracket attached to the engine and having a through hole that is open in a left-right direction. The pivot shaft is inserted through the through hole of the pivot bracket and supported on the left upper frame and the right upper frame.

Thus, the pivot shaft is inserted through the pivot bracket rather than the crankcase. Therefore, the position of the pivot shaft can be adjusted by changing the shape, etc., of the pivot bracket. Therefore, the vehicle body characteristics of the straddled vehicle can be adjusted without changing the structure of the crankcase. Furthermore, the pivot shaft is supported not only by the pivot bracket but also by the left upper frame and the right upper frame. Therefore, it is easier to ensure the desired vehicle body rigidity and vehicle body strength without increasing the size or weight of the pivot bracket.

The engine may include a crankshaft extending in a left-right direction and a crankcase supporting the crankshaft. The down frame may include a connecting portion connected to the crankcase.

Thus, it is possible to improve the vehicle body rigidity and the vehicle body strength of the straddled vehicle.

The engine may include a crankshaft extending in a left-right direction and a crankcase supporting the crankshaft. The down frame may include a connecting portion located downward relative to the crankshaft and connected to the crankcase.

Thus, it is possible to further improve the vehicle body rigidity and the vehicle body strength of the straddled vehicle.

The left upper frame and the right upper frame may each have a rear end. The pivot shaft may be arranged forward relative to the rear ends of the left upper frame and the right upper frame.

Thus, the loads on the pivot shaft generated by the driving force and the braking force of the engine can be effectively received by the left upper frame and the right upper frame. As a result, it is possible to reduce the weight of the straddled vehicle. The shock absorbing capacity of the straddled vehicle is also improved.

The pivot bracket may be arranged between the left upper frame and the right upper frame for the left-right direction.

Thus, the driving force of the engine and the inertial force acting on the engine can be received while being distributed between the left upper frame and the right upper frame. As a result, it is possible to reduce the weight of the straddled vehicle. It is also possible to reduce the left-right difference of the vehicle body rigidity.

The pivot bracket may be spaced apart from the left upper frame and the right upper frame.

Thus, it is possible to reduce the size of the pivot bracket as compared to when the pivot bracket is not spaced apart from the left upper frame and the right upper frame. Thus, it is possible to reduce the weight of the straddled vehicle.

The engine may include a crankshaft extending in a left-right direction and a crankcase supporting the crankshaft. The pivot bracket may include an upper fixed portion fixed to the crankcase and located upward relative to the crankshaft, and a lower fixed portion fixed to the crankcase and located downward relative to the crankshaft.

Thus, for example, input in the rotational direction around the drive shaft can be received while being distributed. As a result, it is possible to reduce the weight of the straddled vehicle. It is also possible to reduce the vibration around the drive shaft, for example.

The pivot bracket may include: a main body portion with a through hole formed therein; a left upper leg portion extending upward from a left upper portion of the main body portion; a right upper leg portion extending upward from a right upper portion of the main body portion; a left lower leg portion extending downward from a left lower portion of the main body portion; and a right lower leg portion extending downward from a right lower portion of the main body portion. The left upper leg portion, the right upper leg portion, the left lower leg portion, and the right lower leg portion may be fixed to the engine.

Thus, the pivot bracket can be stably fixed to the engine.

The main body portion, the left upper leg portion, the right upper leg portion, the left lower leg portion, and the right lower leg portion may be integrally formed.

Thus, it is possible to reduce the number of parts in the straddled vehicle as compared to a configuration where the main body portion, the left upper leg portion, the right upper leg portion, the left lower leg portion, and the right lower leg portion are separate members.

An interval in a left-right direction between an upper end portion (i.e., an uppermost end) of the left upper leg portion and an upper end portion (i.e., an uppermost end) of the right upper leg portion may be longer than a length (i.e.,a width) in the left-right direction of the main body portion. An interval in the left-right direction between a lower end portion (i.e., a lowermost end) of the left lower leg portion and a lower end portion (i.e., a lowermost end) of the right lower leg portion may be longer than the length in the left-right direction of the main body portion.

Thus, the pivot bracket can be stably fixed to the engine.

An upper end portion of the left upper leg portion, an upper end portion of the right upper leg portion, a lower end portion of the left lower leg portion, and a lower end portion of the right lower leg portion may be located forward relative to an axis of the pivot shaft.

Thus, the crankcase and the pivot shaft are arranged spaced apart from each other. Therefore, for example, where the vehicle body characteristics of the straddled vehicle are adjusted by increasing the outer diameter of the pivot shaft, the pivot shaft and the pivot bracket are less likely to interfere with the crankcase. Thus, the range of adjustment, for the vehicle body characteristics of the straddled vehicle is increased.

The pivot bracket may be fastened to the engine by a screw.

Thus, it is possible to easily perform the operation of attaching the pivot bracket to the engine and removing the pivot bracket from the engine. Therefore, it is possible to easily adjust the vehicle body characteristics of the straddled vehicle.

According to the present invention, it is possible to provide a straddled vehicle where the position of the pivot shaft can be changed without changing the structure of the crankcase of the engine and where weight increase is suppressed.

### BRIEF DESCRIPTION OF THE DRAWINGS

FIG. 1 is a left side view of a portion of a motorcycle according to one embodiment.

FIG. 2 is a left side view of the vehicle body frame and the engine according to one embodiment.

FIG. 3 is a right side view of the vehicle body frame and the engine according to one embodiment.

FIG. 4 is a perspective view showing, on an enlarged scale, the vicinity of the front end portion of the swing arm according to one embodiment.

FIG. 5 is a view showing, on an enlarged scale, the vicinity of the pivot bracket in FIG. 2.

FIG. 6 is a perspective view of the pivot bracket according to one embodiment.

FIG. 7 is a rear view showing, on an enlarged scale, the pivot bracket according to one embodiment.

FIG. 8 is a rear view showing, on an enlarged scale, the pivot bracket according to another embodiment.

### DETAILED DESCRIPTION OF THE PREFERRED EMBODIMENTS

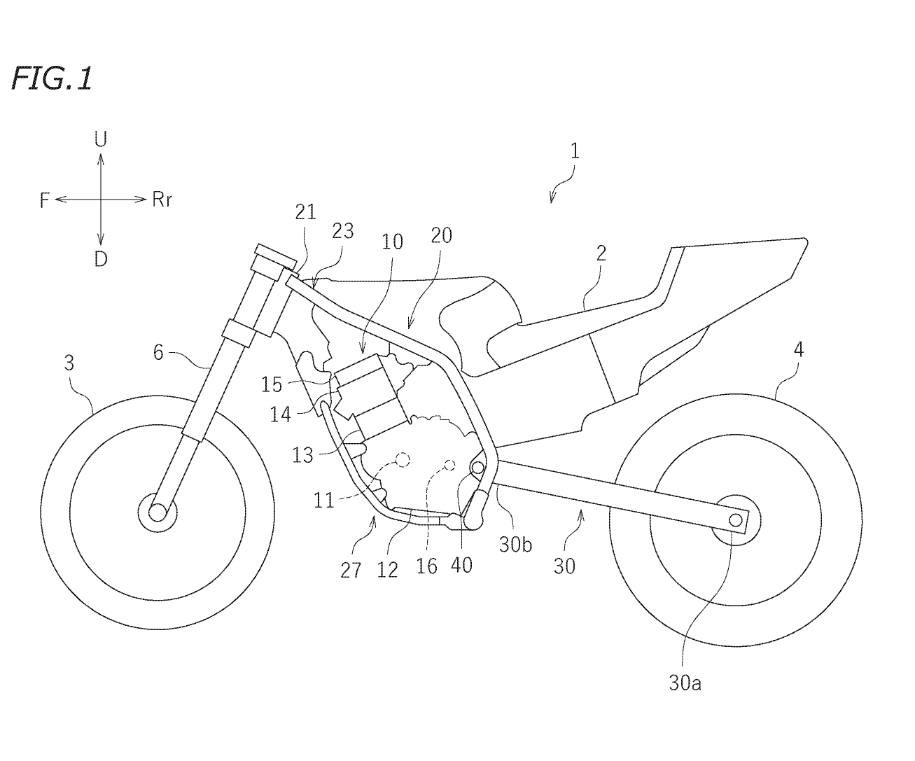

Embodiments of the technology disclosed herein will now be described with reference to the drawings. FIG. 1 is a left side view showing a portion of a motorcycle 1, which is an example of the straddled vehicle.

The terms front, rear, left, right, up and down, as used in the description below, refer to these directions as seen from a virtual rider seated on a seat 2 while the motorcycle 1 is standing upright on a horizontal surface with no rider and no load thereon, unless specified otherwise. The designations F, Rr, L, R, U and D, as used in the figures, refer to front, rear, left, right, up and down, respectively.

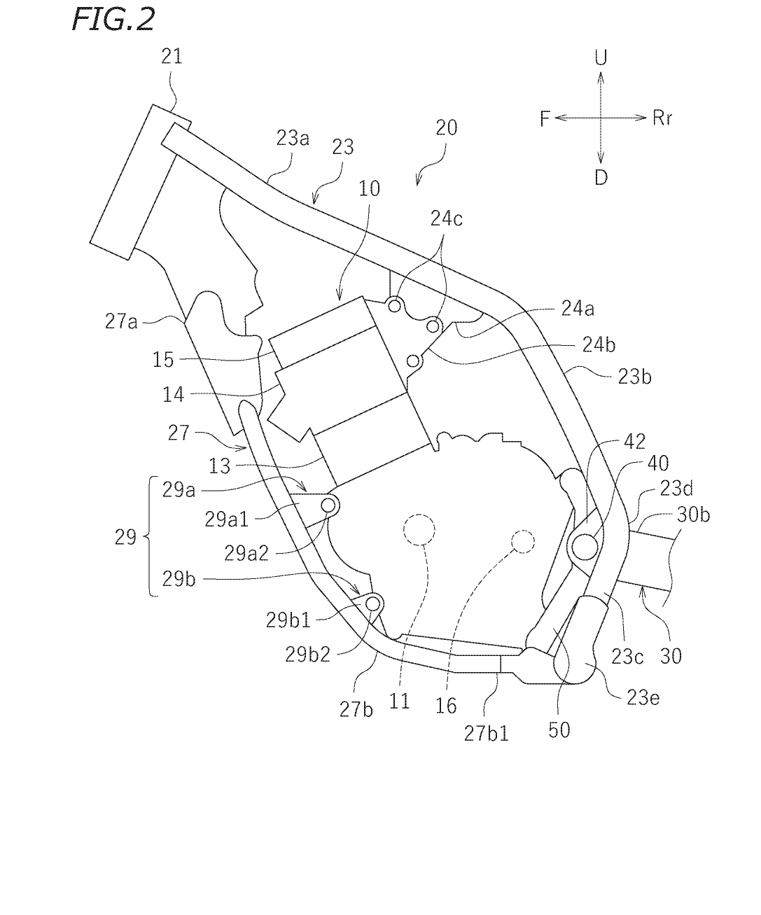

The motorcycle 1 includes the seat 2 on which the rider is seated, a front wheel 3, a rear wheel 4, an engine 10, a vehicle body frame 20, a swing arm 30, a pivot shaft 40, and a pivot bracket 50 (see FIG. 2).

The engine 10 is the power source for driving the motorcycle 1. In the present embodiment, the engine 10 is an internal combustion engine. The engine 10 includes a crankshaft 11, a crankcase 12, a cylinder body 13, a cylinder head 14, a cylinder head cover 15, and a drive shaft 16. The crankshaft 11 extends in the left-right direction. The crankcase 12 supports the crankshaft 11. The crankshaft 11 is arranged inside the crankcase 12. The cylinder body 13 is connected to the crankcase 12. The cylinder body 13 extends upward and forward from the crankcase 12. A cylinder (not shown) is arranged inside the cylinder body 13. A piston (not shown) is arranged inside the cylinder. The cylinder head 14 is connected to the upper portion of the cylinder body 13. The cylinder head cover 15 is connected to the upper portion of the cylinder head 14. The drive shaft 16 is arranged rearward relative to the crankshaft 11. Although not shown, the drive shaft 16 and the rear wheel 4 are linked together by a power transmission mechanism such as a chain.

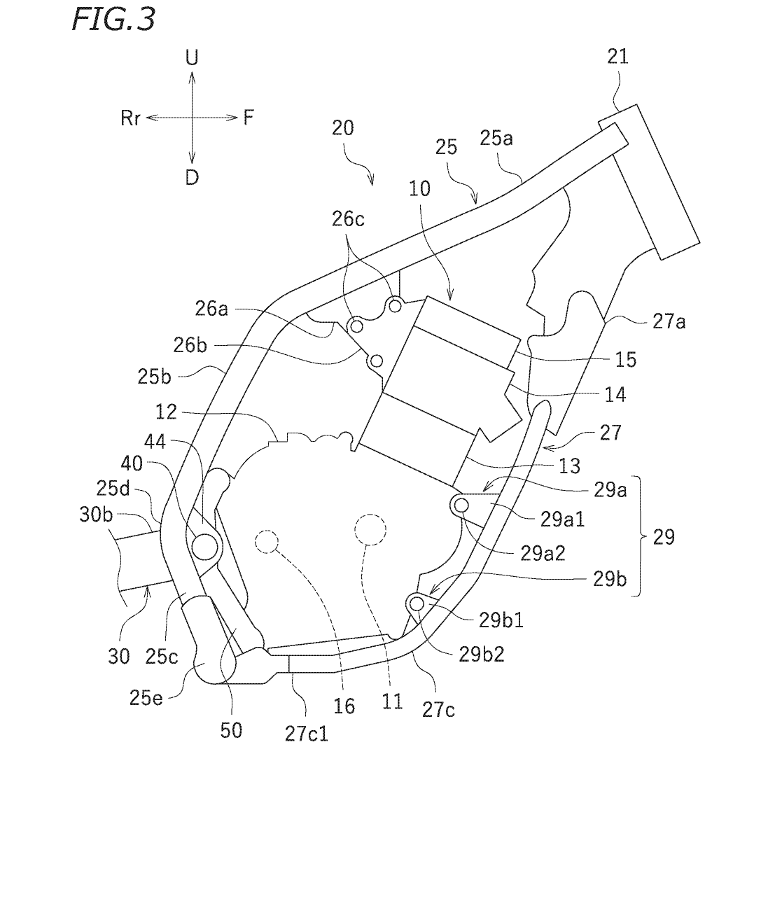

FIG. 2 is a left side view of the vehicle body frame 20 and the engine 10. FIG. 3 is a right side view of the vehicle body frame 20 and the engine 10. In FIGS. 2 and 3, the front wheel 3, the rear wheel 4, the seat 2, etc., are not shown. The vehicle body frame 20 is arranged so as to surround the engine 10. As shown in FIGS. 2 and 3, the vehicle body frame 20 includes a head pipe 21, a left upper frame 23, a right upper frame 25, and a down frame 27.

Although not shown, a steering shaft is inserted into the head pipe 21. Although not shown, a handlebar is connected to the upper portion of the steering shaft. The lower portion of the steering shaft is connected to a front fork 6 (see FIG. 1). As shown in FIG. 1, the front wheel 3 is connected to the lower end portion of the front fork 6.

As shown in FIG. 2, the left upper frame 23 is connected to the head pipe 21. In the present embodiment, the left upper frame 23 is directly connected to the head pipe 21. The left upper frame 23 extends rearward from the head pipe 21. The left upper frame 23 is arranged so as to surround the upper portion and the rear portion of the engine 10. In the present embodiment, the left upper frame 23 includes a first portion 23a, a second portion 23b, and a third portion 23c. In the present embodiment, the first portion 23a, the second portion 23b, and the third portion 23c are formed by a single hollow tube. This tube may be made of, for example, a metal material. Note however that the first portion 23a, the second portion 23b, and the third portion 23c may be formed by solid members. The first portion 23a is connected to the head pipe 21. The first portion 23a extends rearward and downward from the head pipe 21. The second portion 23b is connected to the rear end of the first portion 23a. The second portion 23b extends rearward and downward from the rear end of the first portion 23a. The inclination angle of the second portion 23b is greater than the inclination angle of the first portion 23a. Here, the inclination angle of the second portion 23b refers to the angle formed between the horizontal plane and the second portion 23b, and the inclination angle of the first portion 23a refers to the angle formed between the horizontal plane and the first portion 23a. The third portion 23c is connected to the lower end of the second portion 23b. The third portion 23c extends forward and downward from the second portion 23b.

The right upper frame 25 is connected to the head pipe 21. In the present embodiment, the right upper frame 25 is directly connected to the head pipe 21. The right upper frame 25 extends rearward from the head pipe 21. The right upper frame is arranged rightward of the left upper frame 23. The right upper frame 25 is arranged so as to surround the upper portion and the rear portion of the engine 10. The right upper frame 25 has the same shape as the left upper frame 23 and is arranged in left-right symmetry with the left upper frame 23. As does the left upper frame 23, the right upper frame 25 includes a first portion 25a, a second portion 25b, and a third portion 25c. The configurations of the first portion 25a, the second portion 25b, and the third portion 25c of the right upper frame 25 are similar to those of the left upper frame 23, and therefore the detailed description thereof is omitted here.

The left upper frame 23 has a rear end 23d. In the present embodiment, the rear end 23d of the left upper frame 23 is the rear end of the boundary portion between the second portion 23b of the left upper frame 23 and the third portion 2 3 c of the left upper frame 23. The right upper frame 25 has a rear end 25d. In the present embodiment, the rear end 25d of the right upper frame 25 is the rear end of the boundary portion between the second portion 25b of the right upper frame 25 and the third portion 25c of the right upper frame 25. The rear end 23d of the left upper frame 23 and the rear end 25d of the right upper frame 25 are located rearward relative to the engine 10.

The left upper frame 23 and the right upper frame 25 support the engine 10. In the present embodiment, the left upper frame 23 and the right upper frame 25 support the cylinder head 14 of the engine 10. In the present embodiment, a bracket 24a attached to the first portion 23a of the left upper frame 23 and a bracket 24b attached to the cylinder head 14 are fastened together by screws 24c. A bracket 26a attached to the first portion 25a of the right upper frame 25 and another bracket 26b attached to the cylinder head 14 are fastened together by screws 26c. Note that the configuration for supporting the engine 10 on the left upper frame 23 and the right upper frame 25 is not limited to the present embodiment.

The down frame 27 is connected to the head pipe 21. The down frame 27 may be connected to the head pipe 21 directly or indirectly via another member. The down frame 27 extends rearward. Strictly speaking, the down frame 27 extends rearward and downward. The down frame 27 is arranged so as to surround the front portion and the lower portion of the engine 10. The down frame 27 is arranged downward relative to the left upper frame 23 and the right upper frame 25. The down frame 27 includes a base portion 27a, a left down tube 27b, and a right down tube 27c. The left down tube 27b and the right down tube 27c have the same shape and are arranged in left-right symmetry.

The base portion 27a extends rearward and downward from the head pipe 21. The left down tube 27b and the right down tube 27c are connected to the base portion 27a. The right down tube 27c is arranged rightward relative to the left down tube 27b. The left down tube 27b and the right down tube 27c extend rearward and downward from the base portion 27a. In the present embodiment, the left down tube 27b and the right down tube 27c have the same shape and are arranged in left-right symmetry. In the present embodiment, the left down tube 27b is formed by a single hollow tube, and the right down tube 27c is formed by a single hollow tube. These tubes may be formed, for example, from a metal material. Note however that the left down tube 27b and the right down tube 27c may be formed by solid members.

In the present embodiment, a rear end portion 27b1 of the left down tube 27b is connected to a lower end portion 23e of the left upper frame 23. Similarly, in the present embodiment, a rear end portion 27c1 of the right down tube 27c is connected to a lower end portion 25e of the right upper frame 25.

The down frame 27 supports the engine 10. The down frame 27 includes a connecting portion 29 connected to the crankcase 12. In the present embodiment, the connecting portion 29 includes two first connecting portions 29a and two second connecting portions 29b. The two first connecting portions 29a are located upward relative to the crankshaft 11. One of the two first connecting portions 29a is provided on the left down tube 27b, and the other of the two first connecting portions 29a is provided on the right down tube 27c. In the present embodiment, the first connecting portion 29a includes a first support member 29a1 provided on the left down tube 27b or the right down tube 27c, and a screw 29a2 that fastens together the first support member 29a1 and the crankcase 12. The two second connecting portions 29b are located downward relative to the crankshaft 11. One of the two second connecting portions 29b is provided on the left down tube 27b, and the other of the two second connecting portions 29b is provided on the right down tube 27c. In the present embodiment, the second connecting portion 29b includes a second support member 29b1 provided on the left down tube 27b or the right down tube 27c, and a screw 29b2 for fastening together the second support member 29b1 and the crankcase 12.

As shown in FIG. 1, the swing arm 30 extends in the front-rear direction. The swing arm 30 includes a rear end portion 30a and a front end portion 30b. The rear end portion 30a of the swing arm 30 rotatably supports the rear wheel 4.

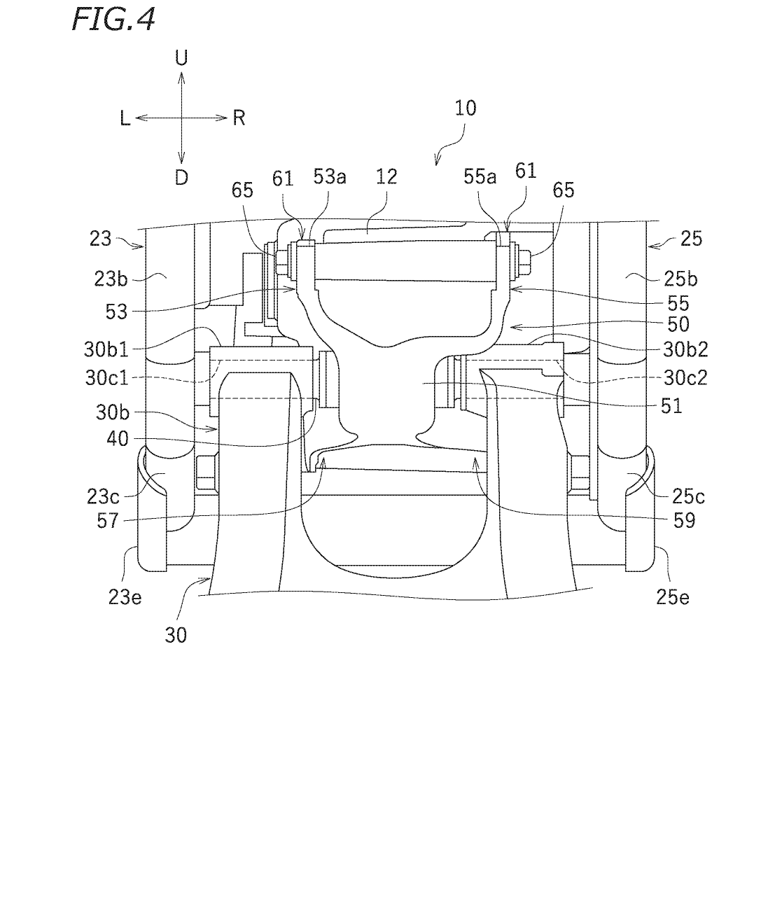

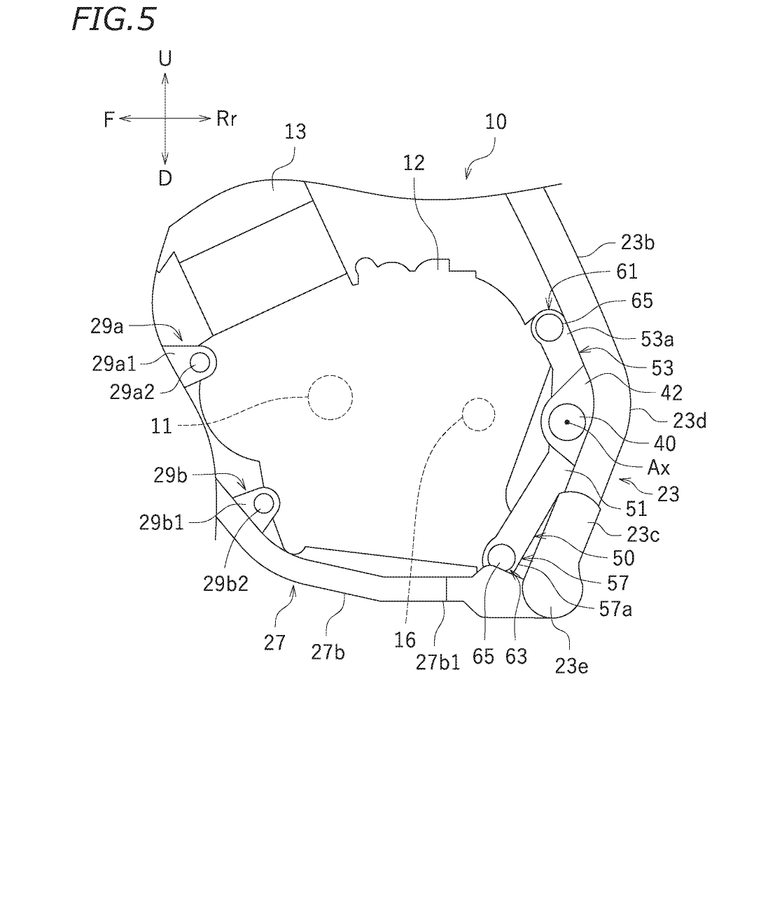

FIG. 4 is a perspective view showing, on an enlarged scale, the vicinity of the front end portion 30b of the swing arm 30. FIG. 5 is a view showing, on an enlarged scale, the vicinity of the pivot shaft 40 in FIG. 2. The front end portion 30b includes a left front end portion 30b1 and a right front end portion 30b2. The left front end portion 30b1 is arranged leftward relative to the right front end portion 30b2. A through hole 30c1, which is open in the left-right direction, is formed in the left front end portion 30b1 of the swing arm 30, and a through hole 30c2, which is open in the left-right direction, is formed in the right front end portion 30b2. As viewed from the left-right direction, at least a part of the front end portion 30b of the swing arm 30 overlaps with the lower end portion of the second portion 23b and the upper end portion of the third portion 23c of the left upper frame 23, and overlaps with the lower end portion of the second portion 25b and the upper end portion of the third portion 25c of the right upper frame 25.

The pivot shaft 40 pivotally supports the front end portion 30b of the swing arm 30. In the present embodiment, the pivot shaft 40 supports the swing arm 30 by being inserted through the through hole 30c1 formed in the left front end portion 30b1 of the swing arm 30 and the through hole 30c2 formed in the right front end portion 30b2. The pivot shaft 40 extends in the left-right direction. As shown in FIG. 5, the pivot shaft 40 is arranged rearward relative to the engine 10. In the present embodiment, the pivot shaft 40 is arranged forward relative to the rear end 23d of the left upper frame 23 and the rear end 25d of the right upper frame 25.

As shown in FIGS. 2 and 3, the pivot shaft 40 is supported on the left upper frame 23 and the right upper frame 25. In the present embodiment, the pivot shaft 40 is fixed to a left support bracket 42 attached to the left upper frame 23 and a right support bracket 44 attached to the right upper frame 25. The pivot shaft 40 may be fixed to the left support bracket 42 and the right support bracket 44 using, for example, screws (not shown).

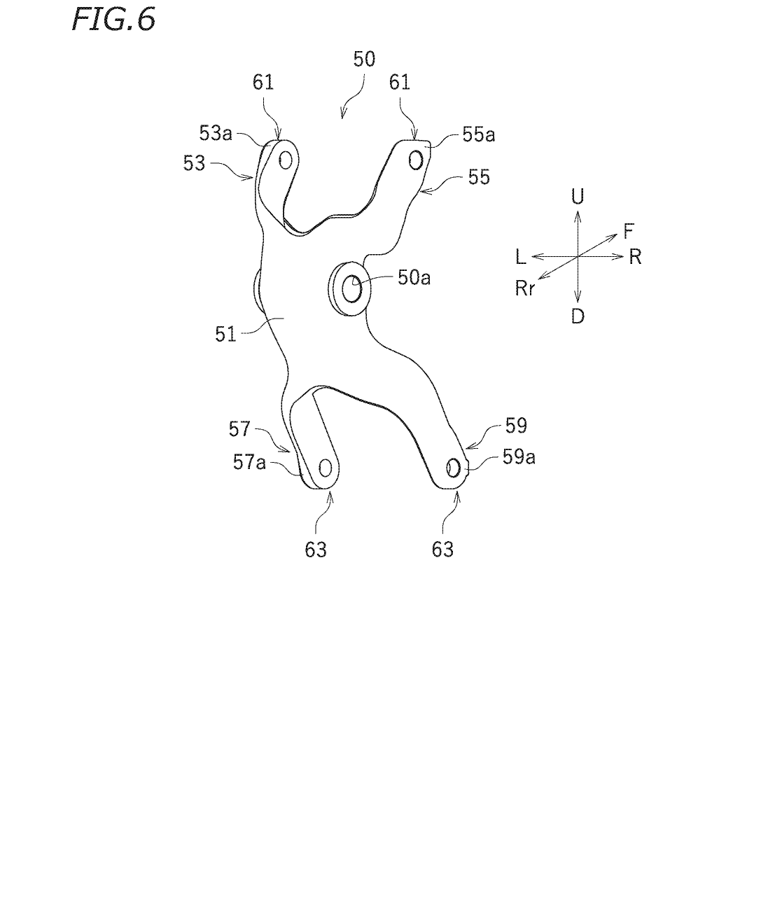

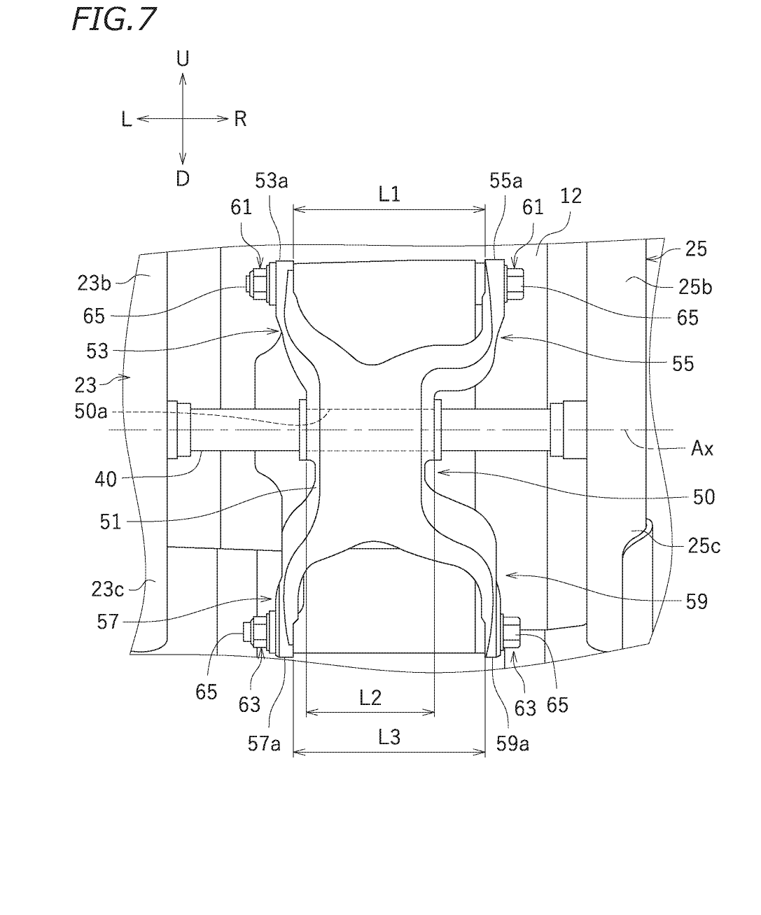

FIG. 6 is a perspective view of the pivot bracket 50. FIG. 7 is a rear view showing, on an enlarged scale, the vicinity of the pivot bracket 50. As shown in FIG. 6, the pivot bracket 50 includes a main body portion 51, a left upper leg portion 53, a right upper leg portion 55, a left lower leg portion 57, and a right lower leg portion 59. The left upper leg portion 53 extends upward from the left upper portion of the main body portion 51. More specifically, the left upper leg portion 53 extends upward and forward from the left upper portion of the main body portion 51. The right upper leg portion 55 extends upward from the right upper portion of the main body portion 51. More specifically, the right upper leg portion 55 extends upward and forward from the right upper portion of the main body portion 51. The left lower leg portion 57 extends downward from the left lower portion of the main body portion 51. More specifically, the left lower leg portion 57 extends downward and forward from the left lower portion of the main body portion 51. The right lower leg portion 59 extends downward from the right lower portion of the main body portion 51. More specifically, the right lower leg portion 59 extends downward and forward from the right lower portion of the main body portion 51. In the present embodiment, the main body portion 51, the left upper leg portion 53, the right upper leg portion 55, the left lower leg portion 57, and the right lower leg portion 59 are integrally formed. That is, in the present embodiment, the pivot bracket 50 is a single-piece member. The pivot bracket 50 may be composed of a metal material, such as a steel material, for example.

The pivot bracket 50 has a through hole 50a, which is open in the left-right direction. In the present embodiment, the through hole 50a is formed in the main body portion 51. The pivot shaft 40 is inserted through the through hole 50a. As shown in FIG. 5, in the present embodiment, an upper end portion 53a of the left upper leg portion 53, an upper end portion 55a of the right upper leg portion 55, a lower end portion 57a of the left lower leg portion 57, and a lower end portion 59a of the right lower leg portion 59 are located forward relative to the axis Ax of the pivot shaft 40. In the present embodiment, the lower end portion 57a of the left lower leg portion 57 and the lower end portion 59a of the right lower leg portion 59 are located forward relative to the upper end portion 53a of the left upper leg portion 53 and the upper end portion 55a of the right upper leg portion 55.

The pivot bracket 50 is attached to the engine 10. More specifically, the pivot bracket 50 is attached to the rear portion of the crankcase 12 of the engine 10. In the present embodiment, the pivot bracket 50 includes upper fixed portions 61 and lower fixed portions 63. The upper fixed portions 61 and the lower fixed portions 63 are fixed to the crankcase 12. In the present embodiment, the upper fixed portions 61 and the lower fixed portions 63 are fastened to the crankcase 12 by screws 65. The upper fixed portions 61 are located upward relative to the crankshaft 11. The lower fixed portions 63 are located downward relative to the crankshaft 11. As shown in FIG. 7, in the present embodiment, the upper fixed portions 61 are the upper end portion 53a of the left upper leg portion 53 and the upper end portion 55a of the right upper leg portion 55. The lower fixed portions 63 are the lower end portion 57a of the left lower leg portion 57 and the lower end portion 59a of the right lower leg portion 59. That is, in the present embodiment, the pivot bracket 50 is attached to the engine 10 by fixing the left upper leg portion 53, the right upper leg portion 55, the left lower leg portion 57, and the right lower leg portion 59 to the crankcase 12.

In the present embodiment, the interval L1 in the left-right direction between the upper end portion 53a of the left upper leg portion 53 and the upper end portion 55a of the right upper leg portion 55 is longer than the length L2 in the left-right direction of the main body portion 51. In the present embodiment, the interval L3 in the left-right direction between the lower end portion 57a of the left lower leg portion 57 and the lower end portion 59a of the right lower leg portion 59 is longer than the length L2 in the left-right direction of the main body portion 51. Here, "the length L2 in the left-right direction of the main body portion 51" refers to the length in the left-right direction at a portion of the main body portion 51 where the length in the left-right direction is largest.

The pivot bracket 50 is located between the left upper frame 23 and the right upper frame 25 for the left-right direction. In other words, the pivot bracket 50 is arranged rightward relative to the left upper frame 23 and leftward relative to the right upper frame 25. In the present embodiment, the pivot bracket 50 is arranged spaced apart from the left upper frame 23 and the right upper frame 25. As shown in FIG. 4, the pivot bracket 50 is arranged between the left front end portion 30b1 and the right front end portion 30b2 of the swing arm 30 for the left-right direction. The main body portion 51 of the pivot bracket 50 is arranged rightward of the left front end portion 30b1 and leftward of the right front end portion 30b2.

According to the present embodiment, the pivot shaft 40 is inserted through the through hole 50a of the pivot bracket 50 attached to the engine 10. With this configuration, the pivot shaft 40 is inserted through the pivot bracket 50 rather than the crankcase 12. Therefore, the position of the pivot shaft 40 can be adjusted by changing the shape, etc., of the pivot bracket 50. Therefore, the vehicle body characteristics of the motorcycle 1 can be adjusted without changing the structure of the crankcase 12. Furthermore, according to the present embodiment, the pivot shaft 40 is supported not only by the pivot bracket 50 but also by the left upper frame 23 and the right upper frame 25. Therefore, it is easier to ensure the vehicle body rigidity and the vehicle body strength of the motorcycle 1 without increasing the size or weight of the pivot bracket 50.

According to the present embodiment, the down frame 27 includes a connecting portion 29 connected to the crankcase 12 of the engine 10. Thus, it is possible to improve the vehicle body rigidity and the vehicle body strength of the motorcycle 1. More specifically, in the present embodiment, the connecting portion 29 includes the second connecting portion 29b located downward relative to the crankshaft 11. Thus, it is possible to further improve the vehicle body rigidity and the vehicle body strength of the motorcycle 1.

According to the present embodiment, the pivot shaft 40 is arranged forward relative to the rear end 23d of the left upper frame 23 and the rear end 25d of the right upper frame 25. The loads on the pivot shaft 40 generated by the driving force and the braking force of the engine 10 can be effectively received by the left upper frame 23 and the right upper frame 25. As a result, it is possible to reduce the weight of the motorcycle 1. The shock absorbing capacity of the motorcycle 1 is also improved.

According to the present embodiment, the pivot bracket 50 is arranged between the left upper frame 23 and the right upper frame 25 for the left-right direction. Thus, the driving force of the engine 10 and the inertial force acting on the engine 10 can be received while being distributed between the left upper frame 23 and the right upper frame 25. As a result, it is possible to reduce the weight of the motorcycle 1. It is also possible to reduce the left-right difference of the vehicle body rigidity.

According to the present embodiment, the pivot bracket 50 is spaced apart from the left upper frame 23 and the right upper frame 25. Thus, it is possible to reduce the size of the pivot bracket 50 as compared to when the pivot bracket 50 is not spaced apart from the left upper frame 23 and the right upper frame 25. Thus, it is possible to reduce the weight of the motorcycle 1.

According to the present embodiment, the pivot bracket 50 includes the upper fixed portions 61 that are fixed to the crankcase 12 and located upward relative to the crankshaft 11, and the lower fixed portions 63 that are fixed to the crankcase 12 and located downward relative to the crankshaft 11. Thus, for example, the input in the rotational direction around the drive shaft 16 can be received while being distributed. As a result, it is possible to reduce the weight of the motorcycle 1. It is also possible to reduce the vibration around the drive shaft 16, for example.

According to the present embodiment, the pivot bracket 50 is fixed to the engine 10 by fixing the left upper leg portion 53, the right upper leg portion 55, the left lower leg portion 57, and the right lower leg portion 59 of the pivot bracket 50 to the engine 10. Thus, the pivot bracket 50 can be stably fixed to the engine 10.

According to the present embodiment, the main body portion 51, the left upper leg portion 53, the right upper leg portion 55, the left lower leg portion 57, and the right lower leg portion 59 of the pivot bracket 50 are integrally formed. Thus, it is possible to reduce the number of parts in the motorcycle 1 as compared to a configuration where the main body portion 51, the left upper leg portion 53, the right upper leg portion 55, the left lower leg portion 57, and the right lower leg portion 59 are separate members.

According to the present embodiment, as shown in FIG. 7, the interval L1 in the left-right direction between the upper end portion 53a of the left upper leg portion 53 and the upper end portion 55a of the right upper leg portion 55 is longer than the length L2 in the left-right direction of the main body portion 51. The interval L3 in the left-right direction between the lower end portion 57a of the left lower leg portion 57 and the lower end portion 59a of the right lower leg portion 59 is longer than the length L2 in the left-right direction of the main body portion 51. Thus, the pivot bracket 50 can be stably fixed to the engine 10.

According to the present embodiment, the upper end portion 53a of the left upper leg portion 53, the upper end portion 55a of the right upper leg portion 55, the lower end portion 57a of the left lower leg portion 57, and the lower end portion 59a of the right lower leg portion 59 are located forward relative to the axis Ax of the pivot shaft 40. Thus, the crankcase 12 and the pivot shaft 40 are arranged spaced apart from each other. Therefore, for example, where the vehicle body characteristics of the motorcycle 1 are adjusted by increasing the outer diameter of the pivot shaft 40, the pivot shaft 40 and the pivot bracket 50 are less likely to interfere with the crankcase 12. Thus, the range of adjustment for the vehicle body characteristics of the motorcycle 1 is increased.

According to the present embodiment, the pivot bracket 50 is fastened to the engine 10 by the screws 65. Thus, it is possible to easily perform the operation of attaching the pivot bracket 50 to the engine 10 and removing the pivot bracket 50 from the engine 10. Therefore, it is possible to easily adjust the vehicle body characteristics of the motorcycle 1.

While one embodiment of the technology disclosed herein has been described above, the embodiment described above is merely illustrative, and various other embodiments are possible.

In the embodiment described above, the left upper frame 23 and the right upper frame 25 are directly connected to the head pipe 21. However, the left upper frame 23 and the right upper frame 25 may be connected to the head pipe 21 via another member. In the present specification, "the left upper frame 23 is connected to the head pipe 21" includes a case where they are connected directly and a case where they are connected indirectly. Similarly, "the right upper frame 25 is connected to the head pipe 21" includes a case where they are connected directly and a case where they are connected indirectly. For example, a single main pipe (not shown) extending rearward may be directly connected to the head pipe 21. The left upper frame 23 and the right upper frame 25 may be directly connected to the main pipe and connected to the head pipe 21 via the main pipe. This main pipe may be a hollow member or a solid member.

The configuration of the down frame 27 is not limited to the embodiment described above. For example, in the embodiment described above, the down frame 27 includes the base portion 27a, the left down tube 27b, and the right down tube 27c. However, for example, the down frame 27 does not need to include the base portion 27a. The left down tube 27b and the right down tube 27c may be directly connected to the head pipe 21.

In the embodiment described above, the rear end portion 27b1 of the left down tube 27b is connected to the lower end portion 23e of the left upper frame 23, and the rear end portion 27c1 of the right down tube 27c is connected to the lower end portion 25e of the right upper frame 25. However, the rear end portion 27b1 of the left down tube 27b does not need to be connected to the lower end portion 23e of the left upper frame 23, and the rear end portion 27c1 of the right down tube 27c does not need to be connected to the lower end portion 25e of the right upper frame 25.

The position where the engine 10 is fixed is not limited to the embodiment described above. For example, in the embodiment described above, the down frame 27 includes the first connecting portion 29a and the second connecting portion 29b. However, for example, the down frame 27 may not include one of the first connecting portion 29a and the second connecting portion 29b.

The shape, etc., of the pivot bracket 50 are not limited to those of the embodiment described above. The pivot bracket 50 only needs to be configured so that the pivot shaft 40 can be inserted therethrough. The pivot bracket 50 does not need to be an integral member. For example, the main body portion 51, the left upper leg portion 53, the right upper leg portion 55, the left lower leg portion 57, and the right lower leg portion 59 of the pivot bracket 50 may be separate members.

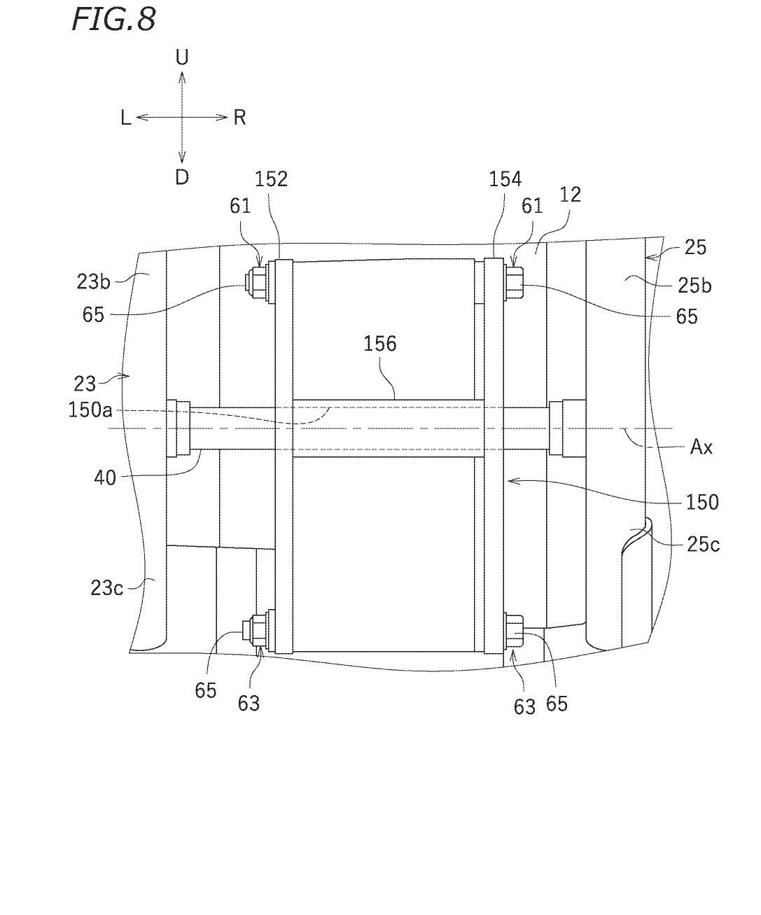

FIG. 8 is a rear view showing, on an enlarged scale, the vicinity of a pivot bracket 150 according to another embodiment. As shown in FIG. 8, the pivot bracket 150 may include a left plate 152, a right plate 154, and a pipe 156. The left plate 152 and the right plate 154 may be plate-like members extending in the up-down direction and the front-rear direction. The left plate 152 and the right plate 154 may be fastened to the crankcase 12 by the screws 65. The right plate 154 may be arranged rightward relative to the left plate 152. The pipe 156 may extend in the left-right direction. The pipe 156 may be formed hollow and may have a through hole 150a, which is open in the left-right direction. The pipe 156 may be connected to the left plate 152 and the right plate 154. The pipe 156 may, for example, be welded to the left plate 152 and the right plate 154. The pipe 156 may be fastened to the left plate 152 and the right plate 154 by screws (not shown). The pipe 156 may have a flange (not shown). The pivot shaft 40 may be inserted through the through hole 150a.

In the embodiment described above, the pivot shaft 40 is arranged forward relative to the rear end 23d of the left upper frame 23 and the rear end 25d of the right upper frame 25. However, the pivot shaft 40 may be arranged, for the front-rear direction, at the same position as the rear end 23d of the left upper frame 23 and the rear end 25d of the right upper frame 25. The pivot shaft 40 may be arranged rearward relative to the rear end 23d of the left upper frame 23 and the rear end 25d of the right upper frame 25.

A straddled vehicle is a vehicle that is straddled by the rider. A straddled vehicle is not limited to the motorcycle 1. For example, a straddled vehicle may be a motor tricycle, an ATV (All Terrain Vehicle), or a snowmobile.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A straddled vehicle comprising:
a head pipe;
a left upper frame connected to the head pipe and extending rearward;
a right upper frame connected to the head pipe, extending rearward, and arranged rightward of the left upper frame;
a down frame connected to the head pipe, extending rearward, and arranged downward relative to the left upper frame and the right upper frame;
an engine that is supported by the left upper frame, the right upper frame, and the down frame;
a swing arm, including:
a front end portion, and
a rear end portion rotatably supporting a rear wheel of the straddled vehicle;
a pivot shaft pivotally supporting the front end portion of the swing arm; and
a pivot bracket attached to the engine, the pivot bracket having a through hole, which is open in a left-right direction of the straddled vehicle, formed therein,
wherein the pivot shaft is inserted through the through hole of the pivot bracket and is supported by the left upper frame and the right upper frame.

2. The straddled vehicle according to claim 1, wherein:
the engine includes
a crankshaft extending in the left-right direction, and
a crankcase supporting the crankshaft; and
the down frame includes a connecting portion connected to the crankcase.

3. 3. The straddled vehicle according to claim 1, wherein:
the engine includes
a crankshaft extending in the left-right direction, and
a crankcase supporting the crankshaft; and
the down frame includes a connecting portion that is located further downward than the crankshaft and is connected to the crankcase.

4. The straddled vehicle according to claim 1, wherein:
the left upper frame and the right upper frame each have a rear end; and
the pivot shaft is arranged further forward than the rear end of each of the left upper frame and the right upper frame.

5. The straddled vehicle according to claim 1, wherein the pivot bracket is arranged between the left upper frame and the right upper frame in the left-right direction.

6. The straddled vehicle according to claim 5, wherein the pivot bracket is spaced apart from each of the left upper frame and the right upper frame.

7. The straddled vehicle according to claim 1, wherein:
the engine includes
a crankshaft extending in the left-right direction, and
a crankcase supporting the crankshaft; and
the pivot bracket includes
an upper fixed portion fixed to the crankcase and located further upward than the crankshaft, and
a lower fixed portion fixed to the crankcase and located further downward than the crankshaft.

8. The straddled vehicle according to claim 1, wherein:
the pivot bracket includes:
a main body portion with a through hole formed therein, the main body portion having a left upper portion, a right upper portion, a left lower portion and a right lower portion;
a left upper leg portion extending upward from the left upper portion of the main body portion;
a right upper leg portion extending upward from the right upper portion of the main body portion;
a left lower leg portion extending downward from the left lower portion of the main body portion; and
a right lower leg portion extending downward from the right lower portion of the main body portion; and
the left upper leg portion, the right upper leg portion, the left lower leg portion, and the right lower leg portion are fixed to the engine.

9. The straddled vehicle according to claim 8, wherein the main body portion, the left upper leg portion, the right upper leg portion, the left lower leg portion, and the right lower leg portion are integrally formed.

10. The straddled vehicle according to claim 8, wherein in the left-right direction,
an interval between an uppermost end of the left upper leg portion and an uppermost end of the right upper leg portion is longer than a width of the main body portion, and
an interval between a lowermost end of the left lower leg portion and a lowermost end of the right lower leg portion is longer than the width of the main body portion.

11. The straddled vehicle according to claim 8, wherein each of an uppermost end of the left upper leg portion, an uppermost end of the right upper leg portion, a lowermost end of the left lower leg portion, and a lowermost end of the right lower leg portion is located further forward than an axis of the pivot shaft.

12. The straddled vehicle according to claim 1, wherein the pivot bracket is fastened to the engine by a screw.
